(19) United States
(12) Patent Application Publication
(10) Pub. No.: US 2024/0416886 A1
(43) Pub. Date: Dec. 19, 2024

(54) ELECTRIC BRAKING DEVICE

(71) Applicant: ADVICS CO., LTD., Kariya-shi, Aichi-ken (JP)

(72) Inventors: Tsuyoshi OTAKE, Kariya-shi, Aichi-ken (JP); Atsushi TAKAHASHI, Kariya-shi, Aichi-ken (JP)

(73) Assignee: ADVICS CO., LTD., Kariya-shi, Aichi-ken (JP)

(21) Appl. No.: 18/703,781

(22) PCT Filed: Oct. 31, 2022
(86) PCT No.: PCT/JP2022/040812

§ 371 Date: Apr. 23, 2024

(30) Foreign Application Priority Data
Nov. 1, 2021 (JP) 2021-178951

(51) Int. Cl. B60T 13/74; B60T 13/16; B60T 13/20

(52) U.S. Cl. CPC B60T 13/745; B60T 13/168; B60T 13/20

(57) ABSTRACT

An electric braking device includes a plurality of electric cylinder devices and a circuit board that controls an electric motor of the electric cylinder devices. The plurality of electric cylinder devices and are disposed adjacent to each other in an alignment direction that is a radial direction of pistons with shaft lines of the pistons parallel to each other. The circuit board is disposed adjacent to the plurality of electric cylinder devices in an orientation in which a board surface of the circuit board is parallel to the shaft lines of the pistons and a longitudinal direction is oriented in the alignment direction.

### TECHNICAL FIELD

The present disclosure relates to an electric braking device that generates a braking force by a wheel by supplying a brake fluid to a wheel cylinder.

### BACKGROUND ART

An electric braking device described in Patent Literature 1 includes an electric cylinder device that supplies and discharges a brake fluid to and from a plurality of wheel cylinders, a chassis that supports the electric cylinder device, a board case attached to the chassis, and a circuit board accommodated in the board case. In the electric braking device, the chassis is disposed between a housing of an electric motor that is a power source of the electric cylinder device and the board case. Furthermore, a cylinder of the electric cylinder device protrudes from the chassis to the inside of the board case. Therefore, the circuit board is designed to avoid contact with a portion of the cylinder protruding into the board case.

### CITATIONS LIST

### Patent Literature

Patent Literature 1: JP 2015-113033 A

### SUMMARY

### Technical Problems

In the above-described electric braking device, a part of the cylinder is located in the board case. Therefore, it is necessary to design the circuit board so as to avoid contact between the cylinder and the circuit board, and there are many restrictions on designing the circuit board.

### Solutions to Problems

An electric braking device for solving the above problem includes a plurality of electric cylinder devices each converting rotational motion of an electric motor into linear motion that drives a piston in a cylinder, and a circuit board that controls the electric motor, and adjusts a braking force applied to a vehicle by operation of the electric cylinder devices. In this electric braking device, the plurality of electric cylinder devices are disposed adjacent to each other in an alignment direction that is a radial direction of the pistons with shaft lines of the pistons being parallel to each other. The circuit board is disposed adjacent to the plurality of electric cylinder devices in an orientation in which a board surface of the circuit board is parallel to the shaft lines of the pistons and a longitudinal direction is oriented in the alignment direction.

Note that the “shaft lines of the pistons being parallel to each other” only needs to be substantially parallel to each other, and includes cases where the shaft lines of the pistons are slightly shifted due to a manufacturing error, an assembly error, or the like.

In the above configuration, the circuit board is disposed adjacent to the plurality of electric cylinder devices. Thus, the circuit board can be designed without considering a size and a shape of the cylinder. Therefore, restrictions on designing the circuit board can be reduced.

Furthermore, since the plurality of electric cylinder devices are supported by a chassis in a manner of being arranged in the alignment direction, the dimension of the electric braking device in the alignment direction tends to be large. Therefore, the circuit board is disposed with respect to the chassis in an orientation in which the longitudinal direction of the circuit board is oriented in the alignment direction. This makes it possible to suppress an increase in size of the electric braking device.

### BRIEF DESCRIPTION OF DRAWINGS

FIG. 1 is a diagram illustrating a cross section of an electric braking device according to an embodiment and a schematic configuration of a friction brake provided for a wheel.

FIG. 2 is a perspective view of the electric braking device.

FIG. 3 is an exploded perspective view of the electric braking device.

FIG. 4 is a plan view in which a part of the electric braking device is broken.

FIG. 5 is a schematic diagram illustrating a positional relationship between shaft lines of a plurality of cylinders and a circuit board in the electric braking device.

FIG. 6 is a perspective view schematically illustrating an electric braking device according to a modification.

### DESCRIPTION OF EMBODIMENT

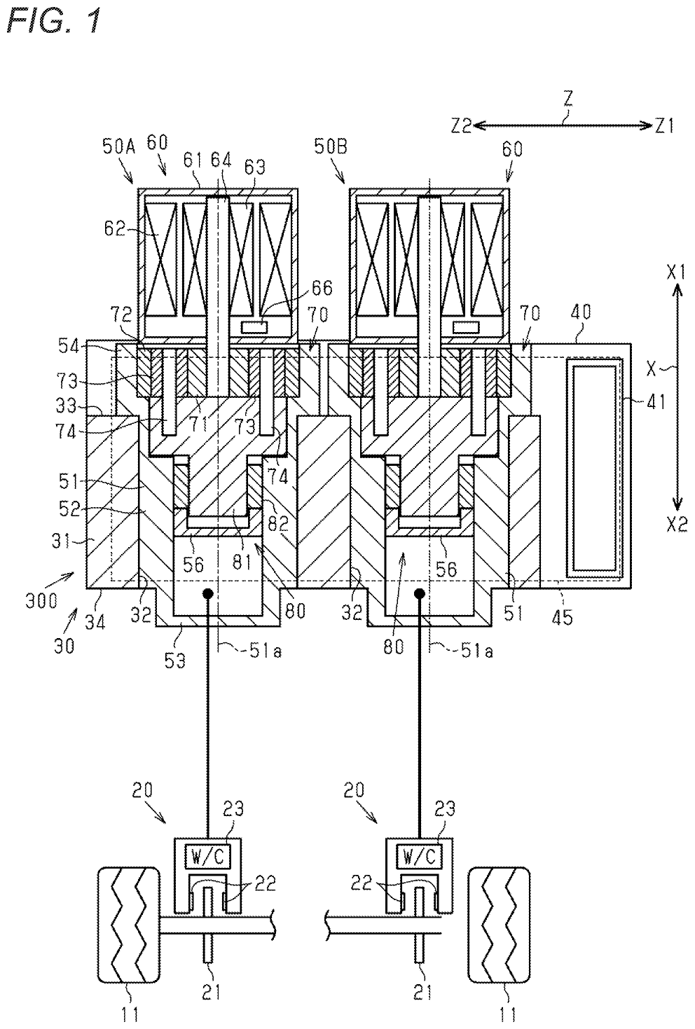

Hereinafter, an embodiment in which an electric braking device is embodied as an electric braking device included in a vehicle will be described with reference to FIGS. 1 to 5.

FIG. 1 illustrates an electric braking device 30 of the present embodiment, a plurality of wheels 11, and a plurality of friction brakes 20. One friction brake 20 is provided for one wheel 11.

<Friction brake 20>

The friction brake 20 includes a portion subjected to friction 21 that rotates integrally with the wheel 11, a friction portion 22, and a wheel cylinder 23. When a brake fluid is supplied to the wheel cylinder 23 and a hydraulic pressure in the wheel cylinder 23 increases, the friction portion 22 is pressed against the portion subjected to friction 21. As a result, a braking force is generated at the wheel 11.

<Electric braking device 30>

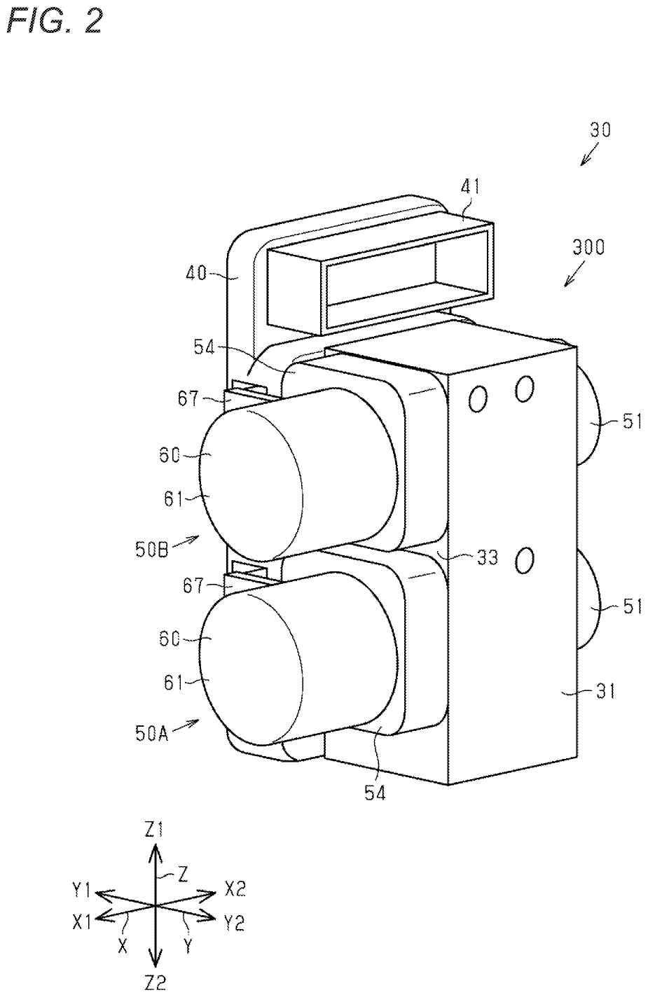

FIG. 2 is a perspective view illustrating the electric braking device 30. FIG. 2 illustrates a first axis X, a second axis Y, and a third axis Z orthogonal to each other. One of two directions along the first axis X is referred to as a first X-axis direction X1, and the other is referred to as a second X-axis direction X2. One of the two directions along the second axis Y is referred to as a first Y-axis direction Y1, and the other is referred to as a second Y-axis direction Y2. One of the two directions along the third axis Z is referred to as a first Z-axis direction Z1, and the other is referred to as a second Z-axis direction Z2. Note that, in the present embodiment, the “direction along the axis” may be substantially the same as an extending direction of the axis, and includes a direction slightly shifted due to a manufacturing error, an assembly error, or the like.

As illustrated in FIGS. 1 and 2, the electric braking device 30 includes an electric cylinder unit 300. The electric cylinder unit 300 includes a chassis 31, a plurality of electric cylinder devices, a board case 40, and a circuit board 45. Then, the electric cylinder unit 300 adjusts a braking force applied to the vehicle by the operations of the electric cylinder devices 50A and 50B. Note that, in the present embodiment, two electric cylinder devices 50A and 50B are provided.

<<Chassis 31>>

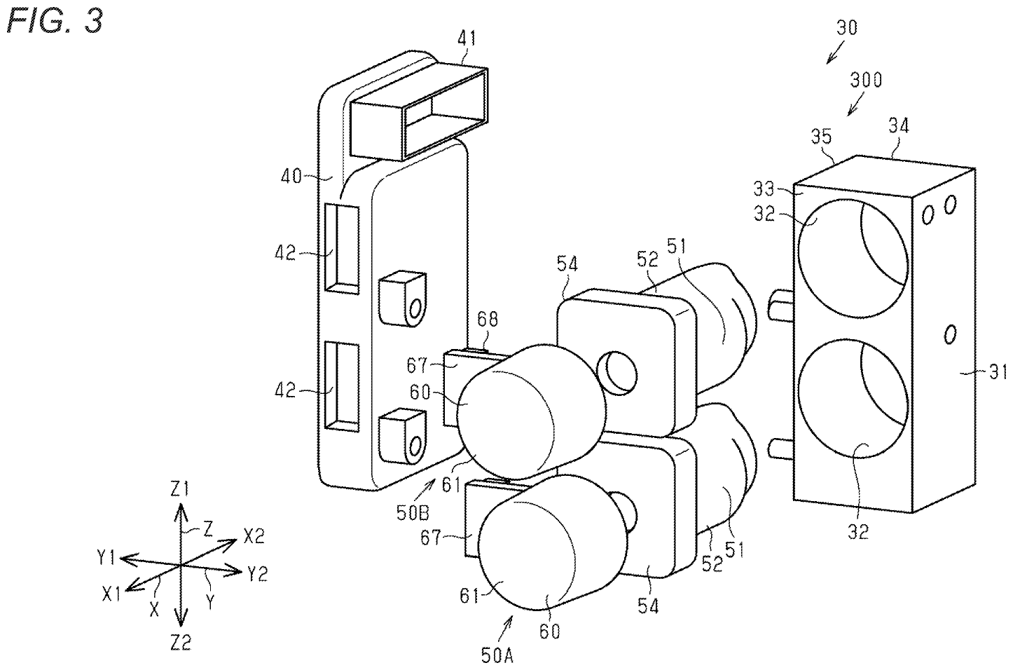

As illustrated in FIGS. 1 and 3, the chassis 31 supports the two electric cylinder devices 50A and 50B. The chassis 31 is provided with an insertion hole 32 that penetrates the chassis 31 in a direction along the first axis X. The chassis 31 is provided with the same number of insertion holes 32 as the electric cylinder devices 50A and 50B. The two insertion holes 32 are arranged in a direction along the third axis Z. The chassis 31 supports the two electric cylinder devices 50A and 50B in a manner in which a part of each of the electric cylinder devices 50A and 50B is accommodated in the insertion hole 32.

Note that the chassis 31 also supports other element components for satisfying the brake system. Examples of the other element components include components connected to the circuit board 45, such as a solenoid actuator and a pressure sensor. Moreover, the chassis 31 also has a function as a liquid path connecting the respective components. For example, the chassis 31 is provided with an oil port for connecting a pipe to the wheel cylinder 23 and a liquid path for connecting the electric cylinder devices 50A and 50B and the above-described solenoid actuator, pressure sensor, and the like.

The chassis 31 has two side surfaces 33 and 34 in which an opening is formed by providing an insertion hole 32 in the chassis 31. Of the two side surfaces 33 and 34, the side surface located in the first X-axis direction X1 is referred to as a supporting side surface 33, and the side surface located in the second X-axis direction X2 is referred to as a protruding side surface 34. The supporting side surface 33 and the protruding side surface 34 are, for example, planes orthogonal to the first axis X. Note that, of the side surfaces of the chassis 31, a side surface connecting an end of the supporting side surface 33 in the first Y-axis direction Y1 and an end of the protruding side surface 34 in the first Y-axis direction Y1 is referred to as a board facing side surface 35. The above-mentioned solenoid actuator and the pressure sensor are disposed on the board facing side surface 35, and are electrically connected to the circuit board 45 provided in the board case 40.

<<Electric cylinder devices 50A and 50B>>

As illustrated in FIG. 1, each of the electric cylinder devices 50A and 50B includes an electric motor 60 as a power source, a rotation transmission mechanism 70, a linear motion conversion mechanism 80, a cylinder 51, and a piston 56. Each of the electric cylinder devices 50A and 50B supplies and discharges a brake fluid to and from the wheel cylinder 23 by a linear motion of the piston 56 in the cylinder 51 according to the drive of the electric motor 60. That is, each of the electric cylinder devices 50A and 50B converts a rotational motion of the electric motor 60 into the linear motion that drives the piston 56 in the cylinder 51.

The cylinder 51 is supported by the chassis 31 in a state of being inserted into the insertion hole 32. Therefore, a shaft line 51a of the cylinder 51 extends in the same direction as a shaft line of the insertion hole 32. That is, the shaft line 51a of the cylinder 51 extends in a direction along the first axis X.

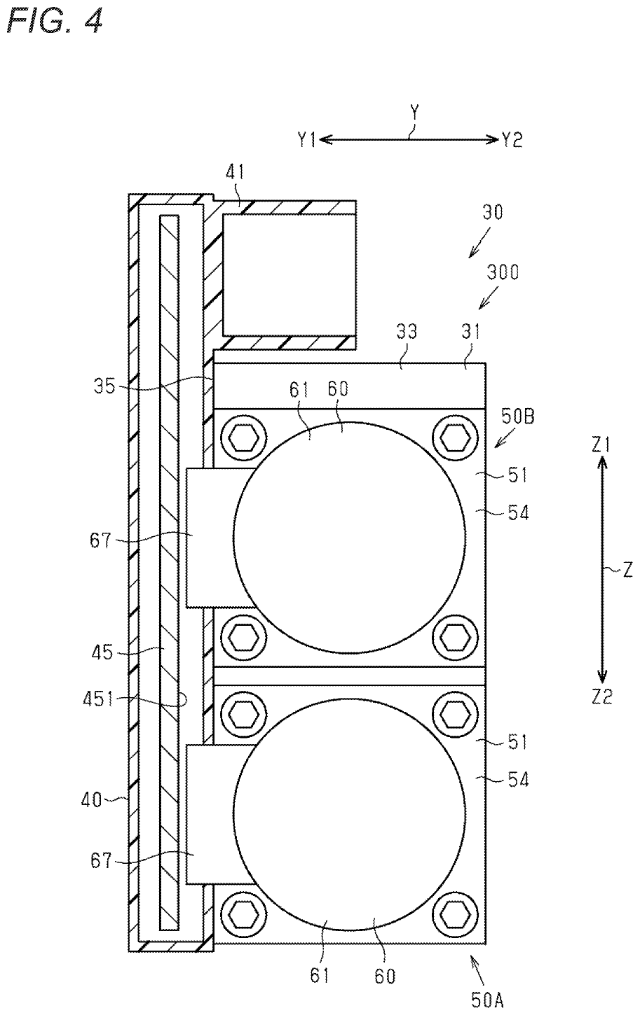

The cylinder 51 includes a cylindrical main body 52, a bottom wall 53 that closes an end of the main body 52 in the second X-axis direction X2, and a flange 54 connected to an end of the main body 52 in the first X-axis direction X1. The flange 54 is in surface contact with the supporting side surface 33 of the chassis 31. Then, for example, as illustrated in FIG. 4, the flange 54 is bolted to the chassis 31.

As illustrated in FIGS. 1 and 2, the main body 52 is inserted through the insertion hole 32. Then, a distal end portion of the main body 52, which is an end portion in the second X-axis direction X2, protrudes from the chassis 31 in the second X-axis direction X2.

As described above, since the two insertion holes 32 are arranged in a direction along the third axis Z, the two electric cylinder devices 50A and 50B are arranged in the direction along the third axis Z. Of the two electric cylinder devices 50A and 50B, one electric cylinder device (for example, the electric cylinder device 50A) is referred to as a “first electric cylinder device”, and the remaining electric cylinder device (for example, the electric cylinder device 50B) is referred to as a second electric cylinder device. At this time, the direction along the third axis Z is an example of a radial direction of the cylinder 51 of the electric cylinder device 50A that is the first electric cylinder device. That is, the direction along the third axis Z corresponds to an “alignment direction” of the plurality of electric cylinder devices 50A and 50B. Therefore, in the present embodiment, the two electric cylinder devices 50A and 50B are supported by the chassis 31 in a manner of being arranged in the above-described alignment direction.

Moreover, in the electric cylinder device 50A that is the first electric cylinder device, the shaft line 51a of the cylinder 51 extends in the direction along the first axis X. Similarly, also in the electric cylinder device 50B that is the second electric cylinder device, the shaft line 51a of the cylinder 51 extends in the direction along the first axis X. That is, the plurality of electric cylinder devices 50A and 50B are disposed such that the shaft lines 51a of the cylinders 51 are parallel to each other.

Here, the shaft line 51a of the cylinder 51 is also a shaft line of the piston 56. Furthermore, the radial direction of the cylinder 51 is also a radial direction of the piston 56. Therefore, in the present embodiment, it can be said that the plurality of electric cylinder devices 50A and 50B are disposed adjacent to each other in the alignment direction that is the radial direction of the pistons 56 with the shaft lines of the pistons 56 parallel to each other.

Note that in a case where the electric cylinder unit 300 is disassembled, the cylinder 51 can be detached from the chassis 31 by releasing the fixation between the flange 54 and the chassis 31. That is, the two electric cylinder devices 50A and 50B are supported by the chassis 31 in a manner of being detachable from the chassis 31 by relatively moving the cylinders 51 with respect to the chassis 31 in the first X-axis direction X1. That is, in the present embodiment, the first X-axis direction X1 corresponds to a “removal direction” in which the electric cylinder devices 50A and 50B are relatively moved with respect to the chassis 31 when the electric cylinder devices 50A and 50B are removed from the chassis 31.

The piston 56 moves forward and backward in the cylinder 51 in a direction in which the shaft line 51a of the cylinder 51 extends. That is, the piston 56 is movable in the first X-axis direction X1 and the second X-axis direction X2. When the piston 56 moves in the second X-axis direction X2, the brake fluid is supplied from the inside of the cylinder 51 toward the wheel cylinder 23. On the other hand, when the piston 56 moves in the first X-axis direction X1, the brake fluid is discharged from the wheel cylinder 23 toward the cylinder 51.

The electric motor 60 includes a motor housing 61, a stator 62, a rotor 63, and an output shaft 64 that rotates integrally with the rotor 63. The motor housing 61 is disposed further in the first X-axis direction X1 than the chassis 31. Specifically, the motor housing 61 is fixed to the cylinder 51 in a manner of being placed on the flange 54. The stator 62 and the rotor 63 are accommodated in such a motor housing 61. The output shaft 64 protrudes outside the motor housing 61. The output shaft 64 extends in the direction along the first axis X. Therefore, a shaft line of the electric motor 60 extends in a direction along the shaft line 51a of the cylinder 51. Specifically, the electric motor 60 is disposed coaxially with the cylinder 51. In the present embodiment, the output shaft 64 protrudes from the motor housing 61 in the second X-axis direction X2.

Note that a motor angle sensor 66 that detects a rotation angle of the rotor 63 is provided in the motor housing 61. For example, the motor angle sensor 66 is a resolver. Such a motor angle sensor 66 outputs a detection signal, which is a signal corresponding to the rotation of the rotor 63, to the circuit board 45.

As illustrated in FIGS. 3 and 4, in the present embodiment, the electric motor 60 includes an extending portion 67 extending radially outward from the motor housing 61. Specifically, the extending portion 67 extends from the motor housing 61 in the first Y-axis direction Y1. The extending portion 67 is provided with a male connector 68 protruding in the second X-axis direction X2, that is, toward the board case 40. The male connector 68 is provided with a power reception terminal electrically connected to the electric motor 60 and a sensor terminal that is a terminal to which a signal line of the motor angle sensor 66 is electrically connected.

The rotation transmission mechanism 70 transmits the rotational motion of the electric motor 60 to the linear motion conversion mechanism 80. Specifically, the rotation transmission mechanism 70 is a speed reduction mechanism that reduces the rotational motion of the electric motor 60 and transmits the reduced rotational motion to the linear motion conversion mechanism 80. For example, as illustrated in FIG. 1, the rotation transmission mechanism 70 includes a sun gear 71, a ring gear 72, and a plurality of pinion gears 73. The plurality of pinion gears 73 mesh with both the sun gear 71 and the ring gear 72, and can rotate and revolve. Since the output shaft 64 of the electric motor 60 is connected to the sun gear 71, the sun gear 71 rotates integrally with the output shaft 64. The plurality of pinion gears 73 are connected to the linear motion conversion mechanism 80 via an output pin 74.

The linear motion conversion mechanism 80 converts the rotational motion transmitted from the rotation transmission mechanism 70 into a linear motion and outputs the linear motion to the piston 56. The linear motion conversion mechanism 80 is, for example, a ball screw mechanism or a feed screw mechanism. Such a linear motion conversion mechanism 80 includes a rotation portion 81 to which a plurality of the output pins 74 are connected and a linear motion portion 82. When the rotational motion is transmitted from the plurality of output pins 74 to the rotation portion 81, the rotation portion 81 rotates, and the linear motion portion 82 linearly moves in a direction according to a rotation direction of the rotation portion 81. When the linear motion portion 82 moves in the second X-axis direction X2, the piston 56 is pushed by the linear motion portion 82 to move in the second X-axis direction X2. On the other hand, when the linear motion portion 82 moves in the first X-axis direction X1, the linear motion portion 82 pulls the piston 56 in the second X-axis direction X2, and further, the piston 56 moves in the first X-axis direction X1 by being assisted by the hydraulic pressure in the cylinder 51. In the present embodiment, a screw is employed as the rotation portion 81, and a nut disposed radially outside the screw is employed as the linear motion portion 82.

<<Board case 40 and circuit board 45>>

As illustrated in FIGS. 1 and 2, the board case 40 has a substantially rectangular parallelepiped shape, and the circuit board 45 is accommodated therein. The board case 40 is fixed to the chassis 31. The direction along the first axis X is also the extending direction of the shaft lines 51a of the cylinders 51 of the electric cylinder devices 50A and 50B, and the direction along the third axis Z is the alignment direction. Therefore, it can be said that the board case 40 is adjacent to the chassis 31 in a direction along the second axis Y orthogonal to both the first axis X and the third axis Z. In other words, as illustrated in FIGS. 3 and 4, the board case 40 is fixed to the chassis 31 in an orientation facing the board facing side surface 35. At this time, a dimension of the board case 40 in the direction along the third axis Z is larger than both a dimension of the board case 40 in the direction along the first axis X and a dimension of the board case 40 in the direction along the second axis Y. The dimension of the board case 40 in the direction along the first axis X is larger than the dimension of the board case 40 in the direction along the second axis Y.

A dimension of the board case 40 in the first Z-axis direction Z1 is larger than a dimension of the chassis 31 in the first Z-axis direction Z1. Then, a power supply connector 41 is disposed at an end portion of the board case 40 in the first Z-axis direction Z1. The power supply connector 41 protrudes from the board case 40 in the second Y-axis direction Y2 and is located further in the first Z-axis direction Z1 than the chassis 31. Then, electric power is supplied to the circuit board 45 from an in-vehicle power supply via the power supply connector 41.

A female connector 42 is provided on a side surface of the board case 40 at a position facing the extending portion 67 of the electric motor 60. In the present embodiment, since the two electric motors 60 are provided, two female connectors 42 are arranged in the direction along the third axis Z. The corresponding male connector 68 is fitted to the female connector 42. That is, when the male connector 68 moves in the second X-axis direction X2, the male connector 68 is fitted to the female connector 42. On the other hand, when the male connector 68 moves in the first X-axis direction X1 while the male connector 68 is fitted to the female connector 42, the fitting between the male connector 68 and the female connector 42 is released.

The female connector 42 is provided with a power transmission terminal and a sensor signal reception terminal electrically connected to the circuit board 45. In a case where the male connector 68 is fitted to the female connector 42, the power transmission terminal is connected to the power reception terminal, and the sensor signal reception terminal is connected to the sensor terminal. On the other hand, when the male connector 68 moves relative to the female connector 42 in the first X-axis direction X1 and the fitting between the male connector 68 and the female connector 42 is released, the connection between the power transmission terminal and the power reception terminal is released, and the connection between the sensor signal reception terminal and the sensor terminal is released.

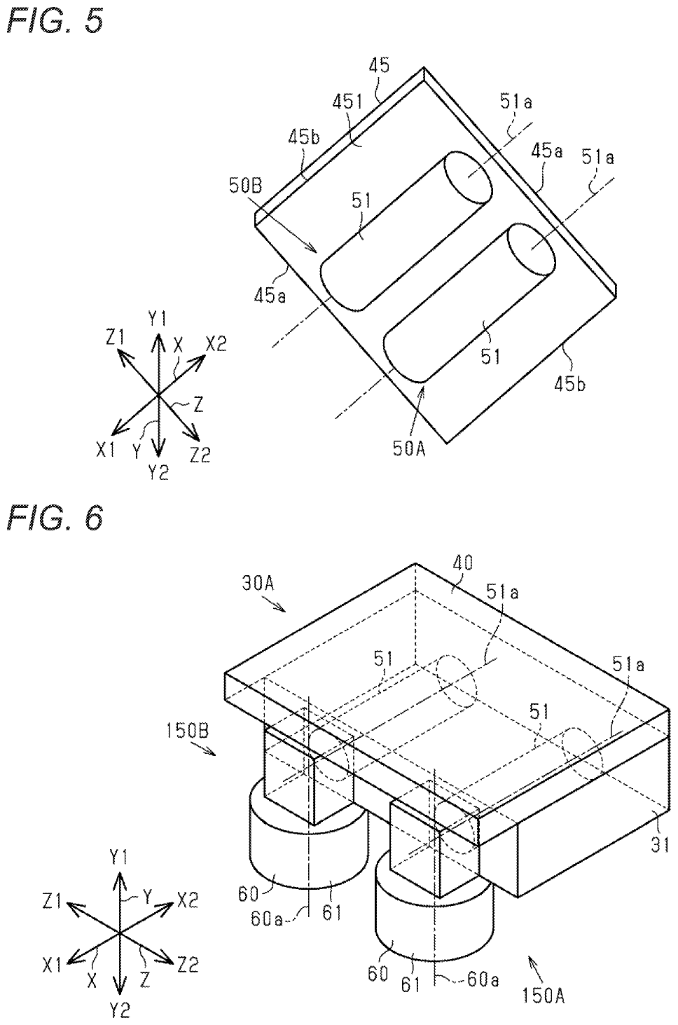

A control unit that controls the plurality of electric motors 60 is mounted on the circuit board 45. As illustrated in FIGS. 1 and 5, such a circuit board 45 has a rectangular plate shape. That is, a peripheral edge of the circuit board 45 has two first edge portions 45a extending in the direction along the third axis Z and two second edge portions 45b extending in the direction along the first axis X. The two first edge portions 45a are parallel, and the two second edge portions 45b are parallel. A length of at least one first edge portion 45a of the two first edge portions 45a is longer than any length of the two second edge portions 45b. Therefore, as illustrated in FIGS. 1 and 4, the circuit board 45 is disposed in an orientation in which a longitudinal direction of a board surface 451 extends in the direction along the third axis Z and a short direction of the board surface 451 extends in the direction along the first axis X.

FIG. 5 schematically illustrates a positional relationship between the shaft lines 51a of the two cylinders 51 and the circuit board 45. As illustrated in FIG. 5, the shaft lines 51a of the two cylinders 51 extend in the direction along the first axis X. Furthermore, the board surface 451 of the circuit board 45 is parallel to both the first axis X and the third axis Z and orthogonal to the second axis Y. That is, the circuit board 45 is disposed in an orientation in which the board surface 451 thereof is oriented parallel to the shaft lines 51a of the cylinders 51.

### Operation and Effect of Present Embodiment

(1) In the present embodiment, the board case 40 is attached to the chassis 31 in a manner of being adjacent to the chassis 31 in the direction along the second axis Y. Therefore, the cylinders 51 of the plurality of electric cylinder devices 50A and 50B are not located in the board case 40. Since the circuit board 45 is accommodated in such a board case 40, a shape of the circuit board 45 can be designed without considering the positions of the cylinders 51. Therefore, restrictions on designing the circuit board 45 can be reduced.

Furthermore, the plurality of electric cylinder devices 50A and 50B are supported by the chassis 31 in a manner of being arranged in the direction along the third axis Z. Thus, a dimension of the electric braking device 30 in the direction along the third axis Z tends to be large. Therefore, the board case 40 is attached to the chassis 31 in an orientation in which the longitudinal direction of the circuit board 45 is oriented in the direction along the third axis Z. This makes it possible to suppress an increase in size of the electric braking device 30.

(2) In each of the electric cylinder devices 50A and 50B, the electric motor 60 is disposed such that the shaft line of the electric motor 60 extends in the direction along the shaft line 51a of the cylinder 51. Moreover, no other member is disposed further in the first X-axis direction X1 than each of the electric cylinder devices 50A and 50B. Therefore, the electric cylinder devices 50A and 50B can be easily moved relative to the chassis 31 in the first X-axis direction X1. That is, the electric cylinder devices 50A and 50B can be easily removed from the chassis 31. Therefore, it is possible to easily perform an operation of replacing the electric cylinder devices 50A and 50B. Furthermore, it is easy to perform work of detaching the electric motors 60 from the electric cylinder devices 50A and 50B.

(3) A capacity of the wheel cylinder 23 varies depending on the type of vehicle on which the electric braking device 30 is mounted. The electric braking device 30 for a vehicle provided with the wheel cylinder 23 having a large capacity is provided with an electric cylinder device including a cylinder having a relatively large volume. On the other hand, the electric braking device 30 for a vehicle provided with the wheel cylinder 23 having a small capacity is provided with an electric cylinder device including a cylinder having a relatively small volume.

An electric cylinder device including a cylinder having a relatively large volume is defined as a large-capacity electric cylinder device. An electric cylinder device including a cylinder having a relatively small volume is defined as a small-capacity electric cylinder device. At this time, a case where the same chassis 31 is used for the large-capacity electric cylinder device and the small-capacity electric cylinder device will be considered. In this case, in order to increase the capacity of the cylinder of the large-capacity electric cylinder device, a dimension of the large-capacity electric cylinder device in a shaft line direction of the cylinder is made larger than a dimension of the small-capacity electric cylinder device in the shaft line direction of the cylinder.

In the present embodiment, no other member is disposed further in the second X-axis direction X2 than the chassis 31. Therefore, cylinders having different dimensions in the direction along the first axis X can be attached to the chassis 31.

<Modifications>

The above embodiment can be modified as follows. The above embodiment and the following modifications can be implemented in combination with each other within a range not technically contradictory.
In the electric cylinder device, the shaft line of the electric motor 60 may be shifted with respect to the shaft line 51a of the cylinder 51. In this case, the shaft line of the electric motor 60 may extend in a direction along the shaft line 51a of the cylinder 51. Moreover, the electric motor 60 may be disposed to overlap the cylinder 51 in the direction of the shaft line 51a of the cylinder 51. In this case, the electric braking device 30 can be reduced in size in the direction of the shaft lines 51a of the cylinder 51. Furthermore, the shaft line of the electric motor 60 may intersect the shaft line 51a of the cylinder 51.

An electric braking device 30A illustrated in FIG. 6 includes a plurality of electric cylinder devices 150A and 150B in which a shaft line 60a of each of electric motors 60 intersects a shaft line 51a of each of cylinders 51. In each of the electric cylinder devices 150A and 150B, the shaft line 60a of the electric motor 60 is orthogonal to the shaft line 51a of the cylinder 51.
The chassis 31 may have a configuration in which a distal end portion of the cylinder 51 can also be accommodated therein.
The electric braking device may be one in which three or more electric cylinder devices are arranged in a predetermined alignment direction. In this case, the electric braking device includes a plurality of second electric cylinder devices.
In the above embodiment, the electric cylinder devices 50A and 50B can be removed from the chassis 31 by relatively moving the electric cylinder devices 50A and 50B in the first X-axis direction X1 with respect to the chassis 31. However, the direction of the relative movement of the electric cylinder devices 50A and 50B when detaching the electric cylinder devices 50A and 50B from the chassis 31 may be a direction different from the first X-axis direction X1. For example, the chassis may be configured such that the electric cylinder devices 50A and 50B can be removed from the chassis by relatively moving the electric cylinder devices 50A and 50B in the second Y-axis direction Y2 with reference to the chassis.
A shape of the circuit board 45 is not limited to the shape described in the above embodiment. That is, the circuit board 45 may not have a rectangular plate shape as long as it has the two first edge portions 45a parallel to each other and the two second edge portions 45b extending in a direction orthogonal to the first edge portions 45a, and the first edge portions 45a are longer than the second edge portions 45b.

1. An electric braking device comprising: a plurality of electric cylinder devices each converting rotational motion of an electric motor into linear motion that drives a piston in a cylinder; and a circuit board that controls the electric motor, the electric braking device adjusting a braking force applied to a vehicle by operation of the electric cylinder devices,
wherein the plurality of electric cylinder devices are disposed adjacent to each other in an alignment direction that is a radial direction of the pistons with shaft lines of the pistons being parallel to each other, and
the circuit board is disposed adjacent to the plurality of electric cylinder devices in an orientation in which a board surface of the circuit board is parallel to the shaft lines of the pistons and a longitudinal direction is oriented in the alignment direction.

2. The electric braking device according to claim 1, wherein
the electric motor is disposed in an orientation in which a shaft line of the electric motor extends in a direction along a shaft line of the piston.

3. The electric braking device according to claim 1, wherein
the electric motor is disposed in an orientation in which a shaft line of the electric motor intersects a shaft line of the piston.
